(19) United States
(12) Patent Application Publication
(10) Pub. No.: US 2018/0290640 A1
(43) Pub. Date: Oct. 11, 2018

(54) METHODS AND APPARATUS TO CONTROL VEHICLE BRAKING SYSTEMS

(71) Applicant: Ford Global Technologies, LLC, Dearborn, MI (US)

(72) Inventors: Bradley J. Johnson, Ann Arbor, MI (US); Patrick McInally, Farmington Hills, MI (US); Christie Bagne, Troy, MI (US)

(21) Appl. No.: 15/480,978

(22) Filed: Apr. 6, 2017

(51) Int. Cl. B60T 13/18; B60T 7/04; B60T 13/16; B60T 13/68; B60T 13/74

(52) U.S. Cl. CPC B60T 13/18; B60T 7/042; B60T 13/166; B60T 2270/402; B60T 13/745; B60T 2270/403; B60T 13/686

(57) ABSTRACT

Methods and apparatus to control vehicle braking systems are described herein. An example apparatus a first brake boost unit to control a first brake fluid pressure of a first brake system associated with front wheels of a vehicle, and a second brake boost unit to control a second brake fluid pressure of a second brake system associated with rear wheels of the vehicle.

### FIELD OF THE DISCLOSURE

This disclosure relates generally to vehicle braking systems and, more particularly, to methods and apparatus to control vehicle braking systems.

### BACKGROUND

Some vehicle braking systems include electric brake systems, which use sensors to detect the braking effect desired by an operator of a vehicle. The sensors measure or detect a force applied to a brake pedal of a vehicle to determine a braking force to be applied to one or more brakes of the vehicle. Typically, a motor controls a pump to vary (e.g., increase or decrease) a fluid pressure of the brakes based on the measured force applied to the brake pedal.

### SUMMARY

An example apparatus includes a first brake boost unit to control a first brake fluid pressure of a first brake system associated with front wheels of a vehicle, and a second brake boost unit to control a second brake fluid pressure of a second brake system associated with rear wheels of the vehicle.

Another example apparatus includes a first motor to control a first brake fluid pressure of first braking components associated with first wheels of a first axle and a first electronic control unit to control the first motor. The apparatus includes a second motor to control a second brake fluid pressure of second braking components associated with second wheels of a second axle different than the first axle and a second electronic control unit to control the second motor. The second electronic control unit is communicatively coupled to the first electronic control unit. The first electronic control unit to operate independently relative to the second electronic control unit.

An example method includes receiving an input, based on the input, determining, via a first brake boost unit, a first brake fluid pressure to provide to a first brake of a first wheel associated with a first axle, and based on the input, determining, via a second brake boost unit, a second brake fluid pressure to provide to a second brake of a second wheel associated with a second axle different from the first axle, wherein the first brake fluid pressure is determined independently from the second brake fluid pressure.

### BRIEF DESCRIPTION OF THE DRAWINGS

FIG. 1 represents an example vehicle that may be implemented with an example vehicle braking system in accordance with the teachings of this disclosure.

FIG. 2A depicts a schematic illustration of the example vehicle braking system and the example vehicle of FIG. 1.

FIG. 2B is a schematic illustration of another example vehicle braking system described herein that may implement the example vehicle of FIG. 1.

FIGS. 3A-3B are flowcharts illustrating example methods to implement the example vehicle braking system of FIGS. 1, 2A, and 2B.

FIG. 4 is a flowchart illustrating another example method to implement the example vehicle braking system of FIGS. 1, 2A, and 2B.

FIG. 5 is a flowchart illustrating another example method to implement the example vehicle braking system of FIGS. 1, 2A, and 2B.

FIG. 6 is a schematic illustration of an example processor diagram that may be used and/or programmed to implement the example methods of FIGS. 3A-5, and more generally, to implement the example vehicle braking system of FIGS. 1-2B.

The figures are not to scale. Wherever possible, the same reference numbers will be used throughout the drawing(s) and accompanying written description to refer to the same or like parts.

### DETAILED DESCRIPTION

Some known vehicles employ brake-by-wire systems that include electric brake boost systems. In some examples, brake boost systems may require fail-functional redundancy to support autonomous driving capability. In some examples, brake boost systems may not be capable of building sufficient brake fluid pressure fast enough to support performance characteristic(s) of certain vehicles such as, for example, medium to heavy duty vehicles (e.g., trucks above 4500-kilograms gross-vehicle weight rating (GVW). Additionally, vehicle braking systems that employ mechanical (e.g., push-through) systems may not be effective in such medium to heavy duty vehicles.

Example apparatus and methods described herein may be used to control brake fluid pressure of a vehicle braking system. Example apparatus and methods disclosed herein provide electrically-powered brake-by-wire systems that can be employed with passenger vehicles, autonomous vehicles, medium to heavy duty vehicles (e.g., vehicles or trucks having Class 3-5 ratings such as, for example, the Ford F-350 and the Ford F-550 manufactured by the Ford Motor Company), and/or any other vehicles.

Generally, the example apparatus and methods disclosed herein provide a dual-motor, brake-by-wire system. In some examples, the vehicle braking system disclosed herein includes a first brake boost unit and a second brake boost unit. Specifically, an example first brake boost unit disclosed herein includes a first pressure generator (e.g., a motor and/or a hydraulic cylinder) and a first electronic control unit, and an example second brake boost unit disclosed herein includes a second pressure generator (e.g., a motor and/or a hydraulic cylinder) and a second electronic control unit. Thus, example apparatus and methods disclosed herein employ dual motors and dual electronic control units to support braking pressure demands of a vehicle.

More specifically, the first motor of the first brake boost unit controls a first brake fluid pressure of a first brake associated with a wheel of a first axle (e.g., a front axle) of the vehicle and the second motor of the second brake boost unit controls a second brake fluid pressure of a second brake or braking system associated with a wheel of a second axle (e.g., a rear axle) of the vehicle different than the first axle. An example first electronic control unit disclosed herein may control the operation of the first motor and an example second electronic control unit disclosed herein may control the operation of the second motor. The second electronic control unit may be communicatively coupled to the first electronic control unit. However, in some such examples, the first control unit operates the first braking system independently from the second control unit's operation of the second braking system even though the first control unit may be communicatively coupled to the second control unit. In some examples, the first and second motors and the first and second electronic control units may be positioned in a housing (e.g., an enclosure or a common module). Additionally, in some examples, the first and second motors and/or the first and second controllers may be supplied power (e.g., electric power) from redundant power sources so that the vehicle braking system disclosed herein can provide boosted braking power during failure of one of the power sources.

In some examples, to operate the first braking system and the second braking system of a vehicle implemented with the example vehicle braking systems disclosed herein, the first and second electronic control units receive an input based on a position of a brake pedal of the vehicle. In some examples, the input received by the first and second electronic control units may include a measured travel distance or a detected position of a brake pedal (e.g., between a first position and a second position) and/or a measured pressure of a master cylinder operatively coupled to the brake pedal (e.g., where movement of the brake pedal increases or decreases a pressure of the master cylinder). Alternatively, the input may include a signal provided to the vehicle braking system via a component (e.g., a vehicle controller) of the vehicle external to the vehicle braking system. For example, a vehicle processor may detect that a cruise control system of the vehicle is operating and may adjust the signal to the brake system accordingly.

For example, the first and second electronic control units may receive an input provided by a travel sensor representative of a position and/or a travel distance of a brake pedal of the vehicle between a first position (e.g., a released position) and a second position (e.g., a depressed position). For example, the travel sensor measures a distance the brake pedal travels between the first position and the second position when the brake pedal is actuated (e.g., pressed) by an operator of the vehicle. The travel sensor communicates the measured distance and/or position value to the first and second electronic control units. The first electronic control unit receives the travel distance and/or position value input and operates the first motor based on the measured distance and/or position value of the brake pedal. Likewise, the second electronic control unit receives the travel distance and/or position value input and operates the second motor based on the measured travel distance and/or position value of the brake pedal. In some examples, the received input may be a pressure of a brake fluid of a master cylinder operatively coupled to the brake pedal. For example, a pressure sensor measures a pressure of brake fluid in the master cylinder based on a position of the brake pedal (e.g., between the first position and the second position) and communicates the measured pressure to the first and second electronic control units. In some examples, the measured pressure of the master cylinder may be used to verify the accuracy of the measured travel distance and/or position value of the brake pedal measured by the travel sensor. Alternatively, in some examples, only the first electronic control unit receives the travel distance and communicates the travel distance to the second electronic control unit. In such examples, the pressure input may be communicated only to the second electronic control unit to provide for a redundancy if the first electronic control unit is not functional. In some examples, only the second electronic control unit receives the pressure inputs and communicates the pressure inputs to the first electronic controller.

Based on the received input, the first brake boost unit determines a first brake fluid pressure to provide to a first brake of a first wheel associated with a first axle of the vehicle and the second brake boost unit determines a second brake fluid pressure to provide to a second brake of a second wheel associated with a second axle of the vehicle. In some examples, the first axle is different than the second axle. In some examples, the first brake fluid pressure is fluidly isolated from the second brake fluid pressure. Thus, example vehicle braking systems disclosed herein include a first brake system (e.g., the first brake boost unit, the first brake, etc.) that operates independent from a second brake system (e.g., the second brake boost unit, the second brake, etc.) different than the first brake system.

Example vehicle braking systems disclosed herein may provide half-boosted braking (e.g., single axle braking) when one of the first brake boost unit or the second brake boost unit is in a fail condition or state (e.g., a non-operational state). To provide half-boosted braking, example vehicle braking systems disclosed herein provide a first brake fluid pressure to the first brake if the second brake boost unit associated with the second brake is in a fail condition, and provides a second brake fluid pressure to the second brake via the second brake boost unit if the first brake boost unit is in a fail condition. If neither the first brake boost unit nor the second brake unit is operational (e.g., both the first brake boost unit and the second brake boost unit are in a fail condition), example vehicle braking systems disclosed herein employ a manual braking system to provide brake fluid pressure to at least one of the first brakes of the front axle or the second brakes of the second axle.

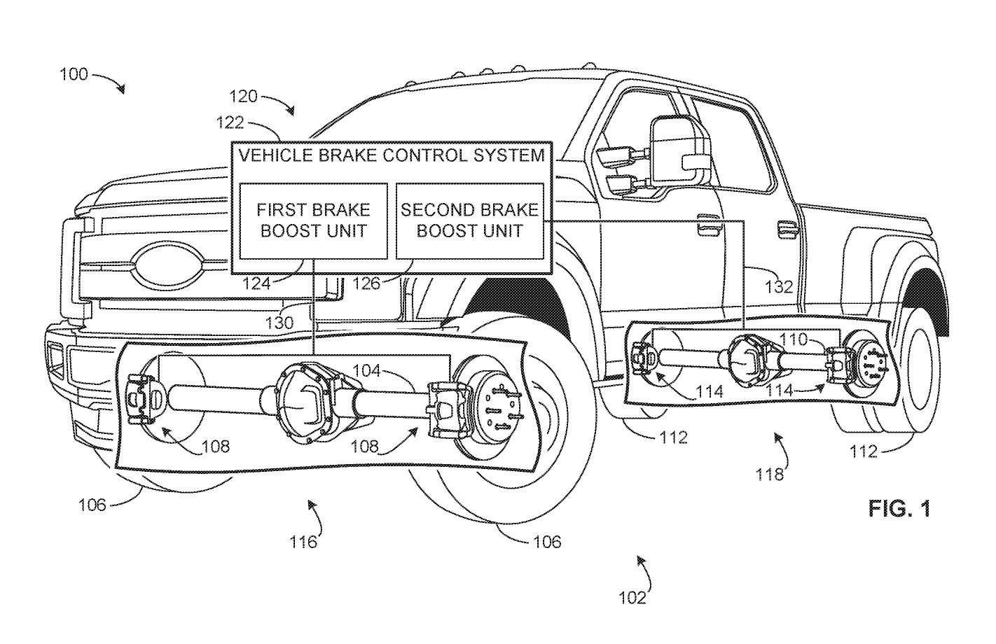

FIG. 1 is an example vehicle 100 implemented with an example vehicle braking system 102 in accordance with the teachings of this disclosure. The vehicle brake system 102 of the illustrated example includes a first braking system portion 116 and a second braking system portion 118. The first braking system portion 116 of the illustrated example operates first brakes 108 of front wheels 106 supported by a front axle 104 and the second braking system portion 118 operates second brakes 114 of rear wheels 112 supported by a rear axle 110. The brakes 108 and/or 114 may include disc brakes having brake pads, calipers, etc. Alternatively, the brakes 108 and/or 114 may be drum brakes or any other types of brakes.

To control the operation of the first brakes 108 and the second brakes 114, the vehicle braking system 102 of the illustrated example includes a vehicle brake control system 120. The vehicle brake control system 120 of the illustrated example includes a first brake boost unit 124 and a second brake boost unit 126. In the illustrated example, the first brake boost unit 124 and the second brake boost unit 126 are disposed in a housing 122. The example housing 122 of the illustrated example is a single housing or enclosure (e.g., a common enclosure). The example housing 122 may be located in an engine compartment or any other suitable location on the vehicle 100. In some examples, the first brake boost unit 124 and the second brake boost unit 126 may not be positioned in the housing 122, but may be positioned in separate housings. For example, the first brake boost unit 124 may positioned in a first housing and the second brake boost unit 126 may be positioned in a second housing different than the first housing.

The first brake boost unit 124 of the illustrated example controls operation of the first brakes 108 of the first wheels 106 (e.g., front wheels) and the second brake boost unit 126 controls operation of the second brakes 114 of the second wheels 112 (e.g., rear wheels). To operate the first brakes 108, the first brake boost unit 124 is operatively coupled (e.g., fluidly coupled) to the first brakes 108 via a first brake fluid line 130. To operate the second brakes 114, the second brake boost unit 126 is operatively coupled (e.g., fluidly coupled) to the second brakes 114 via a second brake fluid line 132. Specifically, the first brake boost unit 124 of the illustrated example varies (e.g., increases or decreases) a first brake fluid pressure in the first brake fluid line 130 to operate the first brakes 108, and the second brake boost unit 126 varies (e.g., increases or decreases) a second brake fluid pressure in the second brake fluid line 132 to operate the rear brakes 114. The first and second brake boost units 124 and 126 of the illustrated example operate independently of each other such that the first brake boost unit 124 does not control the second brake fluid pressure in the second brake fluid line 132 associated with the second brakes 114, and the second brake boost unit 126 does not control the first brake fluid pressure in the first brake fluid line 130 associated with the first brakes 108.

In the illustrated example, the first brake boost unit 124 is dedicated to the first brakes 108 associated with the first axle 104 of the vehicle 100 and the second brake boost unit 126 is dedicated to the second brakes 114 associated with the second axle 110. The association of the first and second brake boost units 124 and 126 to respective axles 104, 110 allows for independent brake fluid pressure control for brakes associated with each axle 104, 110, without the use of control valves that may otherwise be needed when employing brake systems with a single boost unit to control brake fluid pressure to brakes of both axles 104 and 110. This facilitates dynamic proportioning between the front and rear axles 104, 110, which is an advantage for vehicles 100 that implement regenerative braking, and may also be advantageous for an anti-lock braking system (ABS), an electronic stability control (ESC) system, and other stability control functions.

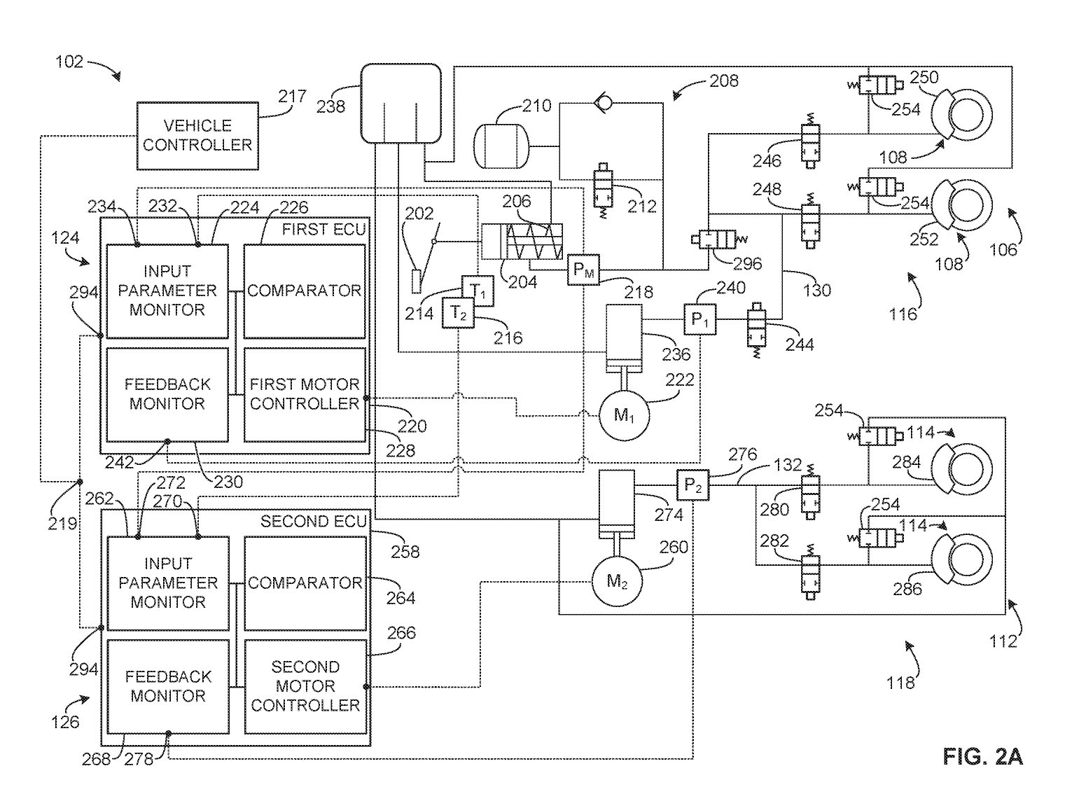

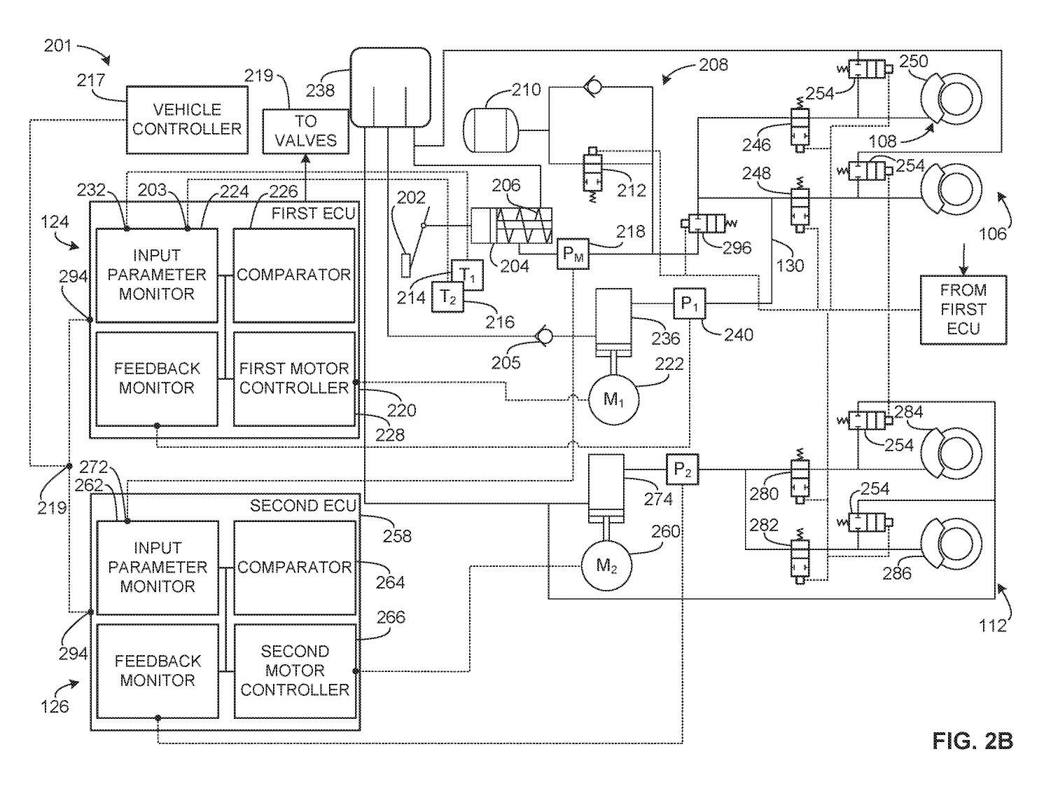

FIG. 2A is an example schematic illustration of the example vehicle brake system 102 of the example vehicle 100 of FIG. 1. The vehicle brake system 102 of the illustrated example includes the first brake system portion 116, the second brake system portion 118, and a simulator circuit 208. In some examples, the vehicle brake system 102 is operated based on a measured input associated with a brake pedal 202 of the vehicle 100. For example, the measured input may be based on a position or travel distance of the brake pedal 202 caused by a force applied to the brake pedal 202 from an operator of the vehicle 100. The brake pedal 202 is operatively coupled to a master cylinder 204, which may include a spring 206 or other biasing element to bias the master cylinder 204 to a non-depressed position (e.g., an initial or non-braking position). The example master cylinder 204 varies (e.g., increases or decreases) a fluid pressure of the simulator circuit 208. To simulate a feedback resistance to the operator of the vehicle 100 based on a force applied to the brake pedal 202 by the operator, the vehicle brake system 202 of the illustrated example includes the simulator circuit 208. The simulator circuit 208 of the illustrated example includes a simulator 210 and a first valve 212. The example valve 212 may be a solenoid valve electrically coupled to the first electronic control unit or, alternatively, may be coupled to a different power source. The simulator 210 of the illustrated example detects a pressure and rate of change of pressure of a brake fluid in the master cylinder 204 and provides the feedback resistance to the pedal 202.

To measure a travel distance and/or a position of the pedal 202 between an initial position (e.g., a non-depressed position or non-braking position) and a second position (e.g., a depressed position), the vehicle braking system 102 of the illustrated example includes a first travel sensor 214 associated with the first brake boost unit 124 and a second travel sensor 216 associated with the second brake boost unit 126. The travel distance measured by the first and second travel sensors 214, 216 is provided to the corresponding one of the first brake boost unit 124 and the second brake boost unit 126 of the vehicle brake control system 120. The first and second brake boost units 124, 126 operate the first and second brakes 108, 114 based on the measured travel distance provided by the first and second travel sensors 214, 216.

Additionally, to measure a fluid pressure (e.g., an outlet) of the master cylinder 204, the vehicle braking system 102 of the illustrated example includes a master cylinder pressure sensor 218. The measured pressure may be used to verify the travel distance measured by the first and second travel sensors 214, 216. For example, if the measured pressure does not correlate with travel distance measured by the travel sensors 214 and 216, the vehicle brake control system 120 may determine that the travel sensors 214 and/or 216 are not functional. If the first and/or the second travel sensors 214, 216 are not functional (e.g., the measured pressure of the master cylinder 204 does not correspond to a travel distance measured by one of the first travel sensor 214 or the second travel sensor 216), the operation of the first and second brakes 108 and 114 is based on the measured pressure from the master cylinder pressure sensor 218 and not the measured input provided by the travel sensors 214 and/or 216.

Additionally or alternatively, an example vehicle controller 217 may provide an input 219 to the example vehicle braking system 102. The vehicle controller 217 may be, for example, a main controller of the vehicle 100 and/or may be connected to other systems of the vehicle 100. For example, the vehicle controller 217 may be operatively or communicatively coupled to a cruise control system and may provide the input 219 to the example vehicle braking system 102 based on a setting of the cruise control system. In some examples, the input 219 may be based on an autonomous vehicle system, an emergency braking system, and/or any other vehicle system having autonomous control capabilities. In the illustrated example, the example input 219 may be communicated to the first brake boost unit 124 and/or the second brake boost unit 126. In other examples, the input 219 may be provided only to the first brake boost unit 124 or only to the second brake boost unit 126.

The first brake boost unit 124 of the illustrated example includes a first electronic control unit 220 and a first motor 222. The first motor 222 is operatively coupled to a first fluid cylinder 236. The first fluid cylinder 236 of the illustrated example provides (e.g., pumps) brake fluid from a brake fluid reservoir 238 to the first brakes 108 via the first brake fluid line 130. The first brake fluid line 130 is fluidly isolated from the second brake fluid line 132 between the first fluid cylinder 236 and the first brakes 108. The brake fluid reservoir 238 is a multi-chamber (e.g., three-chamber) reservoir that supplies brake fluid to the master cylinder 204 and/or the first and second brake boost units 124, 126.

To measure fluid pressure in the first brake line 130, the vehicle brake system 102 of the illustrated example includes a first pressure sensor 240. The first pressure sensor 240 of the illustrated example is coupled (e.g., fluidly coupled) to the first brake fluid line 130 adjacent an outlet of the first fluid cylinder 236 and measures a first brake fluid pressure adjacent an output of the first fluid cylinder 236. In the illustrated example, the first brake fluid line 130 includes a valve 244 positioned downstream from the first motor 222 and the first fluid cylinder 236 to control brake fluid flow through to a third valve 246 and a fourth valve 248 adjacent to the first brakes 108. For example, the third valve 246 of the illustrated example controls brake fluid flow to a front left brake 250 of the first brakes 108 and the fourth valve 248 controls brake fluid flow to a front right brake 252 of the first brakes 108. Additionally, the first brake fluid line 130 of the illustrated example may include anti-lock brake valves 254 positioned adjacent to (e.g., downstream from and in fluid communication with) the third and fourth valves 246, 248 and the first brakes 108. In some examples, the example valves 244, 246, and 248 may be solenoid valves electrically or communicatively coupled to (e.g., receive communication signals from) the first electronic control unit 220. In some examples, the valves 254 may also be solenoid valves electrically or communicatively coupled to the first electronic control unit 220. Additionally or alternatively, the valves 244, 246, 248 and/or 254 may be electrically coupled to a separate power source.

The second brake boost unit 126 of the illustrated example includes a second electronic control unit 258 and a second motor 260. The second motor 260 of the illustrated example is operatively coupled to a second fluid cylinder 274. The second fluid cylinder 274 of the illustrated example provides (e.g., pumps) brake fluid from the brake fluid reservoir 238 to the second brakes 114 via the second brake fluid line 132. The second brake fluid line 132 is fluidly isolated from the first brake fluid line 130 between the second fluid cylinder 274 and the second brakes 114.

To measure fluid pressure in the second brake line 132, the vehicle braking system 102 of the illustrated example includes a second pressure sensor 276. The second pressure sensor 276 of the illustrated example is fluidly coupled to the second brake fluid line 132 adjacent an outlet of the second fluid cylinder 274 to measure a second brake fluid pressure output of the second fluid cylinder 274. In the illustrated example, the second brake fluid line 132 includes a fifth valve 280 and a sixth valve 282 to control brake fluid flow to the second brakes 114 via the second brake fluid line 132. For example, the fifth valve 280 of the illustrated example controls brake fluid flow to a rear left brake 284 of the second brakes 114 and the sixth valve 282 controls brake fluid flow to a rear right brake 286 of the second brakes 114. Additionally, the second brake fluid line 132 of the illustrated example may include anti-lock brake valves 254 positioned adjacent to (e.g., downstream from and in fluid communication with) the fifth and sixth valves 280, 282 and the second brakes 114. The example valves 280 and 282 may be solenoid valves electrically or communicatively coupled to and/or receive communication signals from the first electronic control unit 220. In some examples, the valves 254 may also be electrically or communicatively coupled to the first electronic control unit 220. Additionally or alternatively, the valves 280, 282, and/or 254 may be electrically or communicatively coupled to a separate power source.

The first brake boost unit 124 of the illustrated example operates the first brakes 108 by providing the first brake fluid pressure in the first brake fluid line 130. The first electronic control unit 220 of the illustrated example includes a first input parameter monitor 224, a first comparator 226, a first motor controller 228, and a first feedback monitor 230. The first input parameter monitor 224 of the first electronic control unit 220 receives an input 232 from the first travel sensor 214 and an input 234 from the master cylinder pressure sensor 218. Based on the inputs 232, 234, the first input parameter monitor 224 of the first electronic control unit 220 determines a target first brake fluid pressure to provide to the first brakes 108 of the first wheels 106 via the first motor 222 and the first brake fluid line 130. The first input parameter monitor 224 communicates the target first brake fluid pressure to the first motor controller 228. Based on the determined target first brake fluid pressure, the first motor controller 228 operates the first motor 222. The first feedback monitor 230 of the first electronic control unit 220 is communicatively coupled to the first pressure sensor 240 and receives a pressure feedback input from the first pressure sensor 240.

Similarly, the second brake boost unit 126 of the illustrated example operates the second brakes 114 by providing the second brake fluid in the second brake fluid line 132. The second brake boost unit 126 of the illustrated example includes the second electronic control unit 258 and the second motor 260. The second electronic control unit 258 includes a second input parameter monitor 262, a second comparator 264, a second motor controller 266, and a second feedback monitor 268. The second input parameter monitor 262 of the second electronic control unit 258 receives an input 270 from the second travel sensor 216 and an input 272 from the master cylinder pressure sensor 218. Based on the inputs, the second input parameter monitor 262 determines a target second brake fluid pressure to provide to the second brakes 114 of the second wheels 112. The second input parameter monitor 262 communicates the target second brake fluid pressure to the second motor controller 266. Based on the target second brake fluid pressure, the second motor controller 266 operates the second motor 260. The second feedback monitor 268 of the second electronic control unit 258 is communicatively coupled to the second pressure sensor 276 and receives a second pressure input 278 from the second pressure sensor 276.

The example first brake boost unit 124 and the second brake boost unit 126 may be communicatively coupled via a first input/output 292 of the first electronic control unit 220 and a second input/output 294 of the second electronic control unit 258. The first and second electronic control units 220, 258 are not operative to control opposing brake boost units 124, 126. Enabling communication between the first electronic control unit 220 and the second electronic control unit 258 allows detection of a fail condition of the first or second brake boost units 124 or 126 by the other one of the first or second brake boost units 124 or 126. For example, communication between the first and second brake boost units 124 and 126 allows one of the first electronic control unit 220 or the second electronic control unit 258 to compensate if the other one of the first electronic control unit 220 or the second electronic control unit 258 is not operational (e.g., in a fail condition). For example, if the second electronic control unit 258 or second brake boost unit 126 is not operational, the first electronic control unit 220 may adjust the determined amount of brake fluid pressure that needs to be applied to the front brakes 108 to compensate for the loss of applied brake fluid pressure to the second brakes 114. Thus, the first and second brake boost units 124 and 126 (e.g., dual brake boost units each having an electronic control unit, a motor and a fluid cylinder), may provide increased total braking power output and/or redundant boosted braking.

In operation, the vehicle brake system 102 of the illustrated example is activated when the brake pedal 202 is depressed and brake fluid pressure of the master cylinder 204 is increased. The brake pedal 202 may be depressed from an initial position, in which the operator is not acting (e.g., not applying a force) on the brake pedal 202 and/or the vehicle brake system 102 is not applying a braking force to the wheels 106 via the brakes 108 and/or the wheels 112 via the brakes 114, to a depressed position (e.g., a second position), in which the operator is acting (e.g., applying a force) on the brake pedal 202 and/or the vehicle brake system 102 is applying a braking force to the wheels 106 via brakes 108 and/or the wheels 112 via the brakes 114. The depressed position may include a fully depressed position (e.g., an end of travel position) and/or a partially depressed position. When a force (e.g., from the operator of the vehicle) from the brake pedal 202 is released, the spring 206 moves a piston of the master cylinder 204 to return the pedal 202 to the initial position (e.g., to a non-depressed position). The fluid pressure from the compressed master cylinder 204 flows through the simulator circuit 208, and the simulator 210 provides a resistance to the operator via the brake pedal 202 based on the fluid pressure sensed by the simulator circuit 208. The first valve 212 of the simulator circuit 208 is positioned to an open position during operation of the brake system 102 to enable the brake fluid to flow between the simulator 210 and the master cylinder 204. The pressure of the brake fluid downstream from the master cylinder 204 is measured by the master cylinder pressure sensor 218 and communicated to the input parameter monitor 224 of the first brake boost unit 124 and the input parameter monitor 262 of the second brake boost unit 126.

Additionally, the travel sensors 214, 216 measure the travel distance of the pedal 202 and communicate the travel distance to the respective input parameter monitors 224, 262 of the first and second brake boost units 124 and 126. Based on the travel distance measured by the travel sensors 214, 216, the input parameter monitor 224 of the illustrated example determines a target first brake fluid pressure to provide to the first brakes 108 via the first brake fluid line 130 and the second input parameter monitor 262 determines a target second brake fluid pressure to provide to the second brakes 114 via the second brake fluid line 132. The input parameter monitors 224, 262 may use (e.g., may retrieve information from) a table or chart to determine the corresponding first and target second brake fluid pressures based on the measured travel distance of the brake pedal 202. For example, the input parameter monitors 224 and/or 262 retrieve the respective target first and second brake fluid pressures from a look-up table that includes a travel distance-to-target pressure correlation. For example, the input parameter monitors 224 and/or 262 may retrieve the information from a look-up table stored in memory of the first electronic control unit 220, the second electronic control unit 258, and/or a memory of another electronic control unit of the vehicle. In some examples, the input parameter monitor 224 of the illustrated example may compare (e.g., via the comparator 226) the retrieved target first brake fluid pressure to the input 234 provided by the master cylinder pressure sensor 218 to verify or determine the accuracy of the input 232 provided by the travel sensor 214. Similarly, the input parameter monitor 262 of the illustrated example may compare (e.g., via the comparator 264) the retrieved target second brake fluid pressure to the input 272 provided by the master cylinder pressure sensor 218 to verify or determine the accuracy of the input 272 provided by the second travel sensor 216.

Based on the target first brake fluid pressure, the first motor controller 228 operates the first motor 222 and, based on the target second brake fluid pressure, the second controller 266 operates the second motor 260. For example, the first and second motors 222, 260 move respective pistons of the first and second fluid cylinders 236, 274. For example, the first motor controller 228 controls the operation of the first motor 222 of the illustrated example to cause the first fluid cylinder 236 to provide the target first brake fluid pressure to the first brakes 108 via the first brake fluid line 130. Likewise, the second motor controller 266 controls the operation of the second motor 260 of the illustrated example to cause the second fluid cylinder 274 to provide the target second fluid pressure to the second brakes 114 via the second brake fluid line 132. To stop operation of the first motor 222, the feedback monitor 230 monitors the pressure feedback input 242 and determines when the pressure feedback input 242 is within a threshold (e.g., between 2% and 10%) of the target first pressure brake fluid provided by the input parameter monitor 224. For example, the feedback monitor 230 monitors the pressure feedback input and determines, via the comparator 226, when the pressure feedback input 242 is within a threshold of the target first pressure brake fluid. For example, the feedback monitor 230 instructs the first motor controller 228 to stop operation of the first motor 222 when the first pressure input 242 is substantially equal (e.g., within between 1% and 10%, 2%, etc.) to the target first brake fluid pressure.

Similarly, to stop operation of the second motor 260, the feedback monitor 268 monitors the pressure feedback input 278 and determines when the pressure feedback input 278 is within a threshold (e.g., between 2% and 10%) of the target second brake fluid pressure provided by the input parameter monitor 262. For example, the feedback monitor 268 of the second brake boost unit 126 receives the brake fluid pressure input 278 from the second pressure sensor 276 and compares the second pressure input 278 to the target second brake fluid pressure via, for example, the comparator 264. The feedback monitor 268 instructs the second motor controller 266 to stop operation of the second motor 260 when the second pressure input 278 is substantially equal (e.g., within between 1% and 10%, 2%, etc.) to the target second brake fluid pressure.

During operation, the valves 244, 246, 248, 280, and 282 are in open positions to enable the brake fluid to flow to the respective brakes 250, 252, 284, and 286. A valve 296 positioned between the master cylinder 204 and the third and fourth valves 246, 248 is in a closed position to prevent or restrict brake fluid pressure and/or brake fluid flow from the master cylinder 204 to the brakes 108 during normal operation of the first brake boost unit 124. The example valve 296 may be electrically or communicatively coupled to the first electronic control unit 220. The anti-lock brake valves 254 are in closed positions during operation of the vehicle brake system 102 and may move between open and closed positions during an anti-lock braking system event. For example, in the event an anti-lock brake system is activated, the anti-lock brake valves 254 move to open positions and the valves 244, 246, 248, 280, and 282 move to closed positions to prevent back flow of the brake fluid in the first brake fluid line 130 and/or the second brake fluid line 132.

Further, the vehicle brake system 102 of the illustrated example operates under half-boosted braking conditions when one of the first brake boost unit 124 or the second brake boost unit 126 is in a non-operational state (e.g., is not functional). For example, if the first brake boost unit 124 is functional (e.g., a non-fail condition) and the second brake boost unit 126 is not functional (e.g., in a fail condition), the first brake boost unit 124 operates under normal operating conditions. In some such examples, the first electronic control unit 220 determines the target first brake fluid pressure and operates the first motor 222 to provide the target first brake fluid pressure to the first brakes 108 via the first brake fluid line 130 as noted above. Similarly, if the second brake boost unit 126 is functional (e.g., a non-fail condition) and the first brake boost unit 124 is not functional (e.g., in a fail condition), the second brake boost unit 125 operates under normal operating conditions. In some such examples, the second electronic control unit 258 determines the target second brake fluid pressure and operates the second motor 260 to provide the target second brake fluid pressure to the second brakes 114 via the second brake fluid line 132 as noted above.

In an event where neither the first brake boost unit 124 nor the second brake boost unit 126 is operational (e.g., both the first and second brake boost units 124 and 126 are in a fail condition), the vehicle brake system 102 of the illustrated example employs manual operation of the first brakes 108 based on the pressure of the master cylinder 204. In some such examples, the second valve 244 may be a fail-to-close valve and moves to a closed position to prevent or restrict fluid flow (e.g., backflow of brake fluid) to the first brake boost unit 124 via the first brake line 130 and/or the first fluid cylinder 236. In some such examples, the valve 296, which may be a fail-to-open valve, is positioned downstream of the master cylinder 204 and moves to an open position to allow brake fluid from the master cylinder 204 to flow to the first brakes 108 (e.g., when electric power to the valve 296 is interrupted or removed). The third, fourth, fifth and sixth valves 246, 248, 280, 282 may be fail-to-open valves and move to the open position when neither the first nor the second brake boost units 124, 126 are in an operational state and/or power to the respective valves 246, 248, 280, 282 is interrupted or removed. When the pedal 202 is depressed, the brake fluid from the master cylinder 204 is applied to the first brakes 108 via the valve 296. In such operation of the vehicle brake system 102, the first valve 212 may be in a closed position to fluidly decouple the simulator circuit 208 from the master cylinder 204.

FIG. 2B is another example schematic illustration of an example vehicle brake system 201 that may be used to implement the example vehicle 100 of FIG. 1. Those components of the example vehicle brake system 201 of FIG. 2B that are substantially similar or identical to the components of the vehicle brake system 102 described above and that have functions substantially similar or identical to the functions of those components will not be described in detail again below. Instead, the interested reader is referred to the above corresponding descriptions. To facilitate this process, similar reference numbers will be used for like structures.

In FIG. 2B, the second travel sensor 216 provides an input 203 to the first electronic control unit 220 rather than the second electronic control unit 258. That is, the inputs 232, 203 from both the first travel sensor 214 and the second travel sensor 216 are provided to the input parameter monitor 224 of the first electronic control unit 220. In such examples, the first electronic control unit 220 may communicate the first and/or second travel input 232, 203 to the second electronic control unit 258 via the respective input/outputs 292, 294. Additionally, the first electronic control unit 220 can use the dual travel inputs 232, 203 to monitor the functionality of the first and second travel sensors 214, 216. For example, the first electronic control unit 220 may compare the travel inputs 232, 203. If the travel inputs are not substantially similar, one of the first and second travel sensors 214, 216 may not be functioning properly.

Additionally, the example master cylinder pressure sensor 218 may provide the input 262 to only the second electronic control unit 258 instead of both the first and second electronic control units 220, 258, as shown in the example vehicle brake system 102 of FIG. 2A. Providing the pressure input to the second electronic control unit 258 enables the second electronic control unit 258 to function based on the pressure input in the event the first electronic control unit 220 is not functional and, thus, cannot communicate the inputs 232, 203 to the second electronic control unit 258. In some examples, when the first electronic control unit 220 is functional (e.g., properly functioning), the pressure input 262 may be used by the second electronic control unit 258 to monitor or verify the functionality and/or accuracy of the first and/or the second travel sensors 214, 216.

In the illustrated example of FIG. 2B, the example valve 244 of FIG. 2A is removed. Instead, a non-return valve 205 (e.g., a non-flow back valve, a check valve) may be positioned between the reservoir 238 and the first fluid cylinder 236. The example non-return valve 205 prevents fluid flow back to the reservoir from the first fluid cylinder 236 when, for example, the first brake boost unit 124 is not functional (e.g., loses power, damaged, not working properly, etc.).

As depicted in FIG. 2B, the example valves 296, 212, 246, 248, 254, 280, and 282 are electrically or communicatively coupled to the first electronic control unit 220. The first electronic control unit 220 may also, in some examples, provide a control signal to the valves 296, 212, 246, 248, 254, 280, and 282. Additionally, the first electronic control unit 220 may also provide power to the anti-lock brake valves 254. Thus, if the first electronic control unit 220 is not functional, the valves 296, 246, 248, 254, 280, and 282, which are fail-to-open valves, move to an open position to enable the front brakes 108 to receive brake fluid via the auxiliary braking operation using the master cylinder 204. The second brakes 114 may receive brake fluid via the second brake boost unit 126 if the second brake boost unit 126 is still operational. The example valves 212 and 254 of FIG. 2B are fail-to-close valves and are in the closed position to prevent flow back of the brake fluid when the first electronic control unit 220 is not functional or is in a non-functional state.

While an example manner of implementing the example electronic control units 220, 258 is illustrated in FIGS. 2A and 2B, one or more of the elements, processes and/or devices illustrated in FIGS. 2A and 2B may be combined, divided, re-arranged, omitted, eliminated and/or implemented in any other way. Further, the example input parameter monitors 224, 262, the example comparators 226, 264, the example motor controllers 228, 266, the example feedback monitors 230, 268 and/or, more generally, the example electronic control units 220, 258 of FIGS. 2A and 2B may be implemented by hardware, software, firmware and/or any combination of hardware, software and/or firmware. Thus, for example, any of the example input parameter monitors 224, 262, the example comparators 226, 264, the example motor controllers 228, 266, the example feedback monitors 230, 268 and/or, more generally, the example electronic control units 220, 258 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example input parameter monitors 224, 262, the example comparators 226, 264, the example motor controllers 228, 266, and the example feedback monitors 230, 268 are hereby expressly defined to include a tangible computer readable storage device or storage disk such as a memory, a digital versatile disk (DVD), a compact disk (CD), a Blu-ray disk, etc. storing the software and/or firmware. Further still, the electronic control units 220, 258 of FIGS. 2A and 2B may include one or more elements, processes and/or devices in addition to, or instead of, those illustrated in FIGS. 2A and 2B, and/or may include more than one of any or all of the illustrated elements, processes and devices.

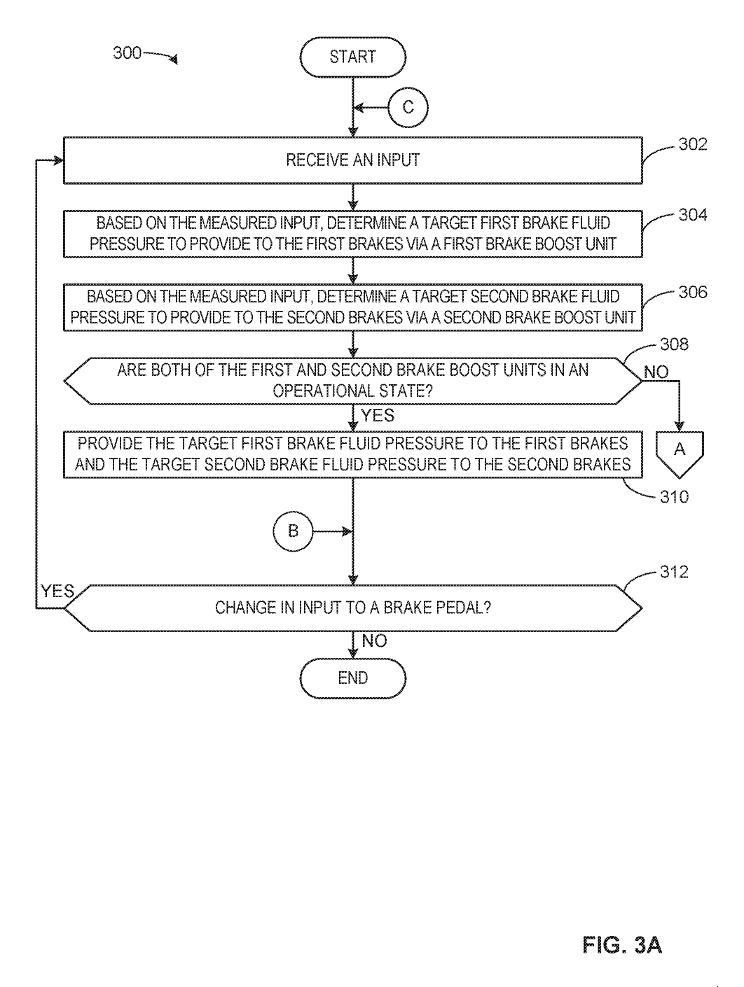

FIGS. 3A, 3B, 4, and 5 represent respective example methods 300, 400, and 500 that may be implemented by the example vehicle braking systems 102 and 201 described herein. In some examples, the methods 300, 400, and 500 may be implemented using machine readable instructions that comprise a program for execution by a processor. Further, although the example methods 300, 400, and 500 are described with reference to the flowchart illustrated in FIGS. 3A, 3B, 4, and 5, many other methods of implementing the examples described herein may alternatively be used. For example, the order of execution of the blocks may be changed, and/or some of the blocks described may be changed, eliminated, or combined.

As mentioned above, the example methods of FIGS. 3A, 3B, 4, and 5 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIGS. 3A, 3B, 4, and 5 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and transmission media.

Turning to FIGS. 3A and 3B, the method 300 begins when the first and second brake boost units 124, 126 receive an input (block 302). For example, the input parameter monitors 234 and 262 of the respective first and second brake boost units 124, 126 receive one or more inputs 219, 232, 234, 270, 272. Based on the input, the first electronic control unit 220 of the first brake boost unit 124 determines a target first fluid pressure to provide to the first brakes 108 of the first wheels 106 (block 304). Additionally, the second electronic control unit 258 of the second brake boost unit 126 determines, based on the input, a target second fluid pressure to provide to the second brakes 114 of the second wheels 112 (block 306). The vehicle braking system 102, 201 of the illustrated example may then determine if both the first and second brake boost units 124, 126 are in an operational state (block 308). In some examples, to determine if the first and second brake boost units 124 and 126 are in an operational state, the first brake boost unit 124 may determine if an operating parameter(s) (e.g., an operating temperature, a voltage, a current, a memory, a processor, etc.) of the second brake boost unit 126 is within a threshold and the second brake boost unit 126 may determine if an operating parameter(s) (e.g., an operating temperature, a voltage, a current, a memory, a processor, etc.) of the first brake boost unit 124 is within a threshold. If both the first and second brake boost units 124, 126 are in an operational state at block 308, the first brake boost unit 124 provides the first brake fluid to the first brakes 108 and the second brake boost unit 126 provides the second brake fluid pressure to the second brakes 114 (block 310). Next, the vehicle braking system 102, 201 determines if the input has changed (block 312). For example, the input parameter monitor 224 determines if the inputs 232 and/or 234 have changed and the input parameter monitor 262 determines if the inputs 270 and/or 272 have changed. If the input to the brake pedal 202 has changed, the vehicle braking system 102, 201 returns to block 302.

If at least one of the first and second brake boost units 124, 126 is not in an operational state at block 308, the vehicle braking system 102, 201 determines if the first brake boost unit 124 is in an operational state (block 314). If the first brake boost unit 124 is in an operational state, the first brake boost unit 124 determines if the target first brake fluid pressure is to be adjusted to compensate for the non-operational state of the second brake boost unit 126 (block 316). If the target first pressure is to be adjusted, the input parameter monitor 224 of the first brake boost unit 124 adjusts the first brake fluid pressure and the first brake boost unit 124 provides the adjusted target first brake fluid pressure to the first brakes 108 (block 318). For example, the input parameter monitor 224 commands the first motor controller 228 to operate the first motor 222 until the feedback monitor 230 determines that a pressure from the first pressure sensor 240 in the first brake line 130 is within a threshold (e.g., between 2% and 10%) of the adjusted target first brake fluid pressure. If adjustment of the target first brake fluid pressure is not necessary, then the first brake boost unit 124 provides the target first brake fluid pressure to the first brakes 108 (block 320).

If, at block 314, the first brake boost unit 124 is not in an operational state, the vehicle braking system 102, 201 may provide brake fluid pressure to the first brakes 108 via the auxiliary brake operation (block 322). To provide auxiliary braking operation, the brake fluid pressure applied to the first brakes 108 may be based on a pressure of the master cylinder 204 caused by movement of the brake pedal 202. For example, if both the first brake boost unit 124 and the second brake boost unit are not in operational states (e.g., fail conditions), the valve 296 moves to the open position and the third, fourth, fifth and sixth valves 246, 248, 280 and 282 move to the closed positions.

The vehicle braking system 102, 201 then determines if the second brake boost unit 126 is in an operational state (block 324). If the second brake boost unit 126 is in an operational state, the second brake boost unit 126 determines if the target second brake fluid pressure is to be adjusted to compensate for the non-operational state of the first brake boost unit 124 (block 326). If the target second pressure is to be adjusted, the input parameter monitor 262 of the second brake boost unit 126 adjusts the target second brake fluid pressure and the second brake boost unit 126 provides the adjusted target second brake fluid pressure to the second brakes 114 (block 328). For example, the input parameter monitor 262 commands the second motor controller 266 to operate the second motor 260 until the feedback monitor 268 determines that a pressure in the second brake line 132 provided by the second pressure 276 is within a threshold (e.g., between 2% and 10%) of the adjusted target second brake fluid pressure. If adjustment of the target second brake fluid pressure is not necessary at block 324, then the second brake boost unit 126 provides the target second brake fluid pressure to the second brakes 114 (block 330).

After the target first brake fluid pressure or the adjusted target first brake fluid pressure is applied to the first brakes 108 at blocks 318 or 320 and/or after the target second brake fluid pressure or the adjusted second brake fluid pressure is applied to the second brakes 114 at blocks 326 or 328, the vehicle braking system 102, 201 determines if an input to the pedal 202 has changed (block 312). If the input to the brake pedal 202 has changed, the vehicle braking system 102, 201 returns to block 302. If, at block 322 the second brake boost unit 126 is not in an operational state, the vehicle braking system 102, 201 may shut down the second brake boost unit 126. (block 332).

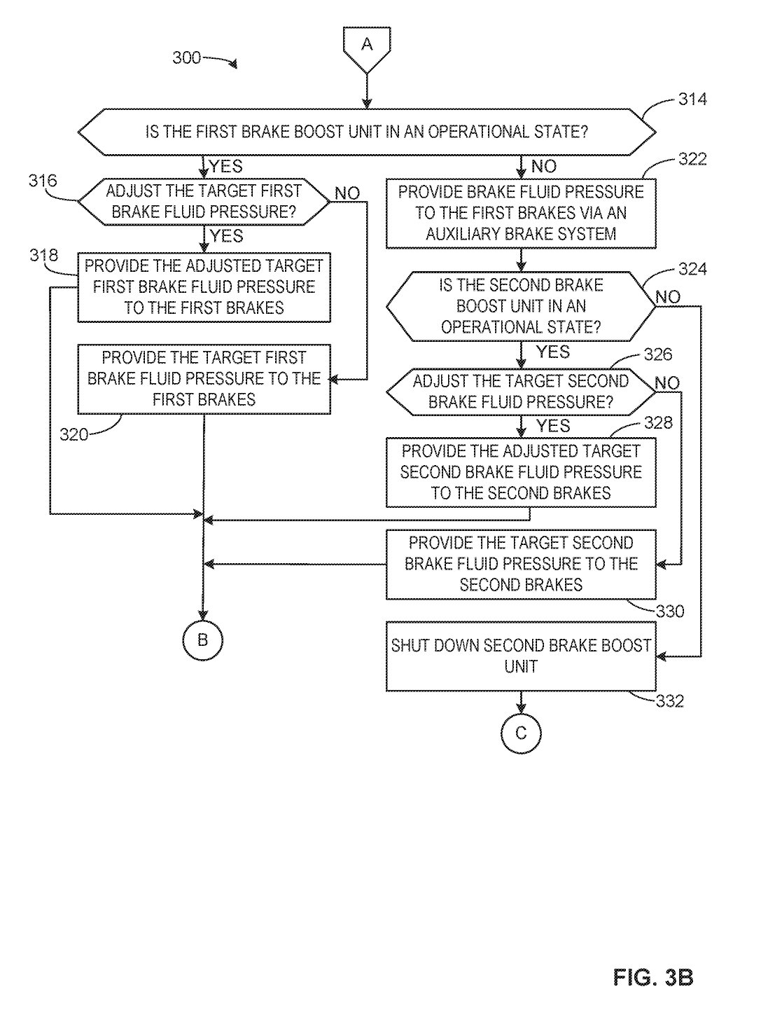

FIG. 4 depicts a flowchart representing the example method 400. The example method beings by determining whether the first brake boost unit 124 is operational (e.g., a non-fail condition) (block 402). If the first brake boost unit 124 is operational, the example braking system 102, 201 determines if the second brake boost unit 126 is operational (e.g., a non-fail condition) (block 404). If the second brake boost unit 126 is operational, the first brake boost unit 124 provides a first target pressure to the first brakes 108 (block 406). If the second brake boost unit 126 is not operational, the first brake boost unit 124 provides an adjusted pressure to the first brakes 108 (block 408). In some examples, the first brake boost unit 124 may not adjust the target pressure when the second brake boost unit 126 is non-operational (e.g., a fail condition). Instead, the target pressure is applied to the first brakes 108. If, at block 402, the first brake boost unit 124 is not functional, brake fluid pressure is provided to the first brakes 108 via an auxiliary or mechanical brake (block 410). For example, an auxiliary brake system is provided by the master cylinder 236.

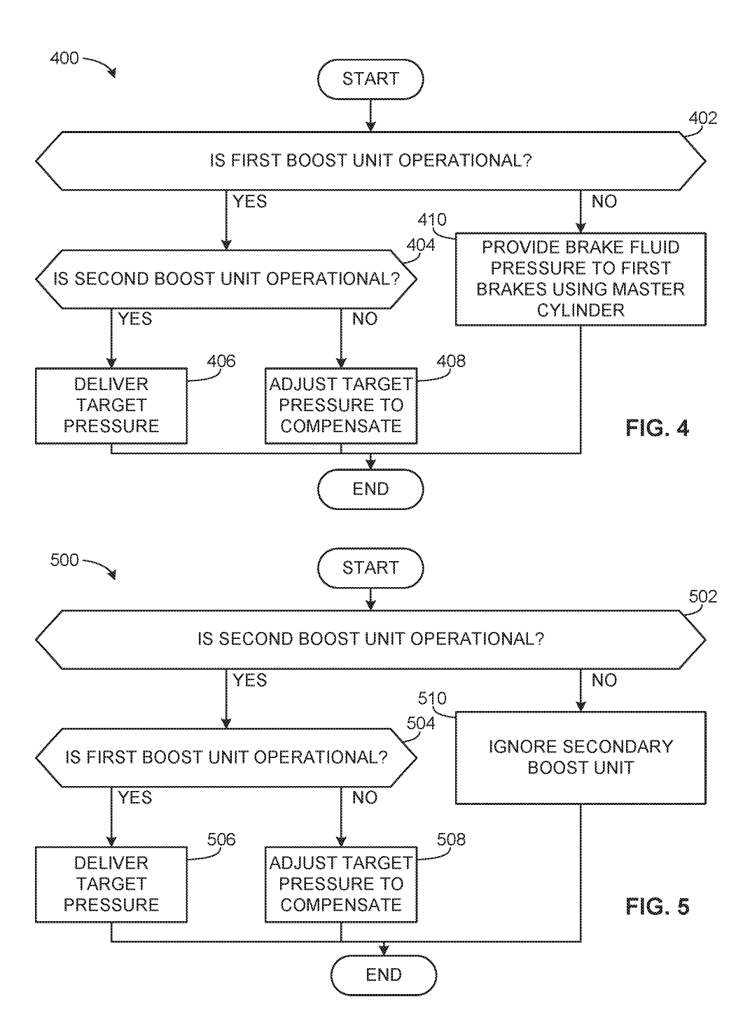

FIG. 5 depicts a flowchart representing the example method 500. The example method beings by determining whether the second brake boost unit 126 is operational (e.g., a non-fail condition) (block 502). If the second brake boost unit 126 is operational, the example braking system 102, 201 determines if the first brake boost unit 124 is operational (e.g., a non-fail condition) (block 504). If the first brake boost unit 124 is operational, the second brake boost unit 126 provides a second target pressure to the second brakes 114 (block 506). If the first brake boost unit 124 is not operational (e.g., a fail condition), the second brake boost unit 126 of the illustrated example provides an adjusted pressure to the second brakes 114 (block 508). In some examples, the second brake boost unit 126 may not adjust the target pressure when the first brake boost unit 124 is non-operational. Instead, the target pressure is applied to the second brakes 114. If, at block 502, the second brake boost unit 126 is not functional, the vehicle brake system 102, 201 ignores the second brake boost unit 126 (block 510). For example, signals to and/or from the second brake boost unit 126 are ignored or not acted upon.

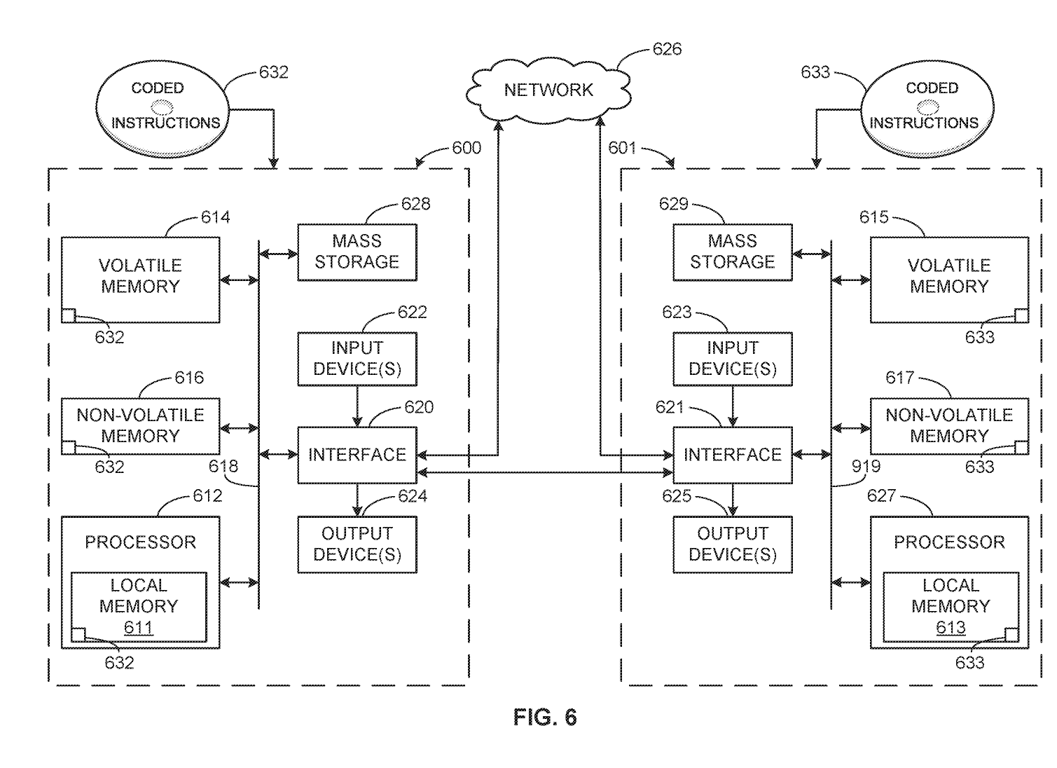

FIG. 6 is a block diagram of example processor platforms 600, 601 capable of executing instructions to implement the method if FIGS. 3A, 3B, 4, and 5 and the apparatus of FIGS. 1 and 2. Each of the processor platforms 600, 601 can be, for example, a server, a personal computer, a vehicle control unit, or any other type of computing device.

The processor platforms 600, 601 of the illustrated example include processors 612, 627. The processors 612, 627 of the illustrated example are hardware. For example, the processors 612, 627 can be implemented by one or more integrated circuits, logic circuits, microprocessors or controllers from any desired family or manufacturer.

The processors 612, 627 of the illustrated example include local memories 611, 613 (e.g., a cache). The processors 612, 627 of the illustrated example are in communication with respective main memories, including respective volatile memories 614, 614 and non-volatile memories 616, 617 via respective buses 618, 619. The volatile memories 614, 615 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memories 616, 617 may be implemented by flash memory and/or any other desired type of memory device. Access to the main memories 614, 615, 616, 617 is controlled by a memory controller.

The processor platforms 600, 601 of the illustrated example also include interface circuits 620, 621. The interface circuits 620, 621 may be implemented by any type of interface standard, such as an Ethernet interface, a universal serial bus (USB), and/or a PCI express interface.

In the illustrated example, one or more input devices 622, 623 are connected to the respective interface circuits 620, 621. The input device(s) 622, 623 permit(s) a user to enter data and commands into the processors 612, 627. The input device(s) can be implemented by, for example, pressure sensors, travel sensors, an audio sensor, a microphone, a camera (still or video), a keyboard, a button, a mouse, a touchscreen, a track-pad, a trackball, isopoint and/or a voice recognition system.

One or more output devices 624, 625 are also connected to the respective interface circuits 620, 621 of the illustrated example. The output devices 624, 625 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuits 620, 621 of the illustrated example, thus, typically includes a graphics driver card, a graphics driver chip or a graphics driver processor.

The interface circuits 620, 621 of the illustrated example also includes a communication device such as a transmitter, a receiver, a transceiver, a modem and/or network interface card to facilitate exchange of data with external machines (e.g., computing devices of any kind) via a network 626 (e.g., an Ethernet connection, a digital subscriber line (DSL), a telephone line, coaxial cable, a cellular telephone system, etc.). The example processor platforms 600, 601 may communicate via the network 626, or may be in direct communication via the respective interfaces 624, 625.

The processor platform 600, 601 of the illustrated example also includes one or more mass storage devices 628, 629 for storing software and/or data. Examples of such mass storage devices 628, 629 include floppy disk drives, hard drive disks, compact disk drives, Blu-ray disk drives, RAID systems, and digital versatile disk (DVD) drives.

Coded instructions to implement the method 300 of FIGS. 3A, 3B, 4, and 5 may be stored in the mass storage devices 628, 629, in the volatile memories 614, 615, in the non-volatile memories 616, 617, and/or on a removable tangible computer readable storage medium such as a CD or DVD.

From the foregoing, it will be appreciated that the above disclosed methods, apparatus and articles of manufacture are operative to provide a dual electric boosted brake system.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
a first brake boost unit to control a first brake fluid pressure of a first brake system associated with front wheels of a vehicle; and
a second brake boost unit to control a second brake fluid pressure of a second brake system associated with rear wheels of the vehicle.

2. The apparatus as described in claim 1, wherein the first brake boost unit operates independently of the second brake boost unit.

3. The apparatus as described in claim 1, wherein the first brake boost unit includes a first motor and a first electronic control unit coupled to the first motor, the first brake boost unit to control the first brake fluid pressure of the first brake system based on an input.

4. The apparatus as described in claim 3, wherein the second brake boost unit includes a second motor and a second electronic control unit, the second brake boost unit to control the second brake fluid pressure of the second brake system based on the input.

5. The apparatus as described in claim 4, wherein the first and second electronic control units are communicatively coupled.

6. The apparatus as described in claim 5, wherein the input includes at least one of a travel distance of a brake pedal to be measured by a travel sensor operatively coupled to the brake pedal of the vehicle, a pressure of a master cylinder to be measured by a pressure sensor coupled to the master cylinder, or a signal provided by a vehicle controller.

7. An apparatus comprising:
a first motor to control a first brake fluid pressure of first braking components associated with first wheels of a first axle;
a first electronic control unit to control the first motor;
a second motor to control a second brake fluid pressure of second braking components associated with second wheels of a second axle different than the first axle; and
a second electronic control unit to control the second motor, the second electronic control unit communicatively coupled to the first electronic control unit, the first electronic control unit to operate independently relative to the second electronic control unit.

8. The apparatus as defined in claim 7, further including a housing, the first and second motors and the first and second electronic control units positioned in the housing.

9. The apparatus as defined in claim 7, wherein the first wheels are front wheels and the second wheels are rear wheels.

10. The apparatus as defined in claim 7, further including a brake pedal and a travel sensor, the travel sensor to measure a distance the brake pedal moves between a first position and a second position.

11. The apparatus as defined in claim 10, wherein the travel sensor is communicatively coupled to at least one of the first electronic control unit or the second electronic control unit, the first electronic control unit to operate the first motor based on the measured distance provided by the travel sensor, and the second electronic control unit to operate the second motor based on the measured distance.

12. The apparatus as defined in claim 10, further including a pressure sensor and a master cylinder, the pressure sensor to measure a pressure of fluid in the master cylinder when the brake pedal moves between the first position and the second position, the pressure sensor being communicatively coupled to at least one of the first electronic control unit or the second electronic control unit.

13. The apparatus as defined in claim 7, further including a vehicle controller, the vehicle controller to provide an input to the at least one of the first electronic control unit or the second electronic control unit to indicate the first brake fluid pressure and the second brake fluid pressure to provide to the first and second brakes.

14. The apparatus as defined in claim 7, wherein the first brake fluid pressure is different from the second brake fluid pressure.

15. The apparatus as defined in claim 7, further including valves positioned between the first motor and the first brake components and between the second motor and the second brake components, wherein the valves are controlled by the first electronic control unit.

16. A method comprising:
receiving an input;
based on the input, determining, via a first brake boost unit, a first brake fluid pressure to provide to a first brake of a first wheel associated with a first axle; and
based on the input, determining, via a second brake boost unit, a second brake fluid pressure to provide to a second brake of a second wheel associated with a second axle different from the first axle, wherein the first brake fluid pressure is determined independently from the second brake fluid pressure.

17. The method as defined in claim 16, wherein the input includes measuring, via a sensor, a travel distance of a brake pedal when the brake pedal moves between a first position and a second position.

18. The method as defined in claim 16, further including controlling a first motor of the first brake boost unit to provide the first brake fluid pressure to the first brake.

19. The method as defined in claim 16, further including controlling a second motor of the second brake boost unit to provide the second brake fluid pressure to the second brake via the second brake boost unit.

20. The method as defined in claim 16, further including detecting a fail condition of at least one of the first brake boost unit or the second brake boost unit, the first brake boost unit to provide the first brake fluid pressure to the first brake when the second brake boost unit is in the fail condition, and the second brake boost unit to provide the second brake fluid pressure to the second brake when the first brake boost unit is in the fail condition.
